(19) United States
(12) Patent Application Publication
(10) Pub. No.: US 2026/0002770 A1
(43) Pub. Date: Jan. 1, 2026

(54) IMAGE MEASURING APPARATUS AND PROGRAM

(71) Applicant: MITUTOYO CORPORATION, Kawasaki (JP)

(72) Inventors: Koji Shinza, Kanagawa (JP); Kenji Tomaru, Tokyo (JP); Hiroyuki Yoshida, Kanagawa (JP); Yuki Yamasaki, Kanagawa (JP)

(21) Appl. No.: 19/249,290

(22) Filed: Jun. 25, 2025

(30) Foreign Application Priority Data
Jul. 1, 2024 (JP) 2024-106492
Mar. 31, 2025 (JP) 2025-059898

(51) Int. Cl. G01B 9/08; G01B 11/02; G01B 11/08; G01B 11/255; G06T 7/00; G06T 7/60

(52) U.S. Cl. CPC G01B 9/08; G01B 11/02; G01B 11/08; G01B 11/255; G06T 7/001; G06T 7/60

(57) ABSTRACT

An image measuring apparatus and program that enable easy designation of measurement points and intuitive, easy-to-understand operation is provided. The image measuring apparatus according to the present invention captures an image of a measurement object, and measures dimensions of measurement points of the measurement object by analyzing the image. The image measuring apparatus comprises: a display unit that displays the image of the measurement object; a measurement support item applying unit that causes the display unit to display a measurement support item superimposed on the image of the measurement object displayed on the display unit; an input unit that accepts input operations by a user for moving the measurement support item.

### CROSS-REFERENCE TO RELATED APPLICATION

This non-provisional application claims priority under 35 U.S.C. § 119 (a) from Japanese Patent Application No. 2024-106492, filed on Jul. 1, 2024, and Patent Application No. 2025-059898, filed on Mar. 31, 2025, the entire contents of which are incorporated herein by reference.

### BACKGROUND

### Technical Field

The present invention relates to an image measuring apparatus that captures an image of a measurement object, analyzes the image, and measures the dimensions of the measurement points of the measurement object, and a program.

### Background Art

An image measuring apparatus is a device that captures an image of a measurement object and measures the dimensions of the measurement point of the measurement object by analyzing the image (see, for example, JP2010-169584A).

### SUMMARY OF THE INVENTION

### Problems to be Solved by the Invention

When measuring with conventional image measuring apparatus, it was necessary to extract elements such as lines and circles to be measured, designate the elements to be measured by the user, and select commands for the desired process, such as line measurement. It was also necessary to set a measurement reference axis in accordance with the orientation of the measurement object appearing in the image. Performing these processes requires a lot of time and effort, and is complicated, and it is difficult for users to intuitively understand what actions they should take.

In addition, when measuring fine details, users must perform detailed operations to designate elements and align positions with visual confirmation. Therefore, there was a problem that it was not suitable for rough handling in environments where detailed operations are difficult, such as at product processing sites.

A purpose of the present invention is to provide an image measuring apparatus and program that enable easy designation of measurement points and intuitive, easy-to-understand operation.

### Means for Solving the Problems

The image measuring apparatus according to the present invention captures an image of a measurement object, and measures the dimensions of measurement points of the measurement object by analyzing the image. The image measuring apparatus comprises: a display unit that displays the image of the measurement object; a measurement support item applying unit that causes the display unit to display a measurement support item superimposed on the image of the measurement object displayed on the display unit; an input unit that accepts input operations by a user for moving the measurement support item.

### Effects of the Invention

According to the image measuring apparatus and program of the present invention, it is possible to overlay the measurement support item on the image of the measurement object. By operating the measurement support item, it is easy to designate the measurement point and set the measurement reference axis, thereby improving visual intuitiveness and usability.

### BRIEF DESCRIPTION OF THE DRAWINGS

FIG. 1 shows an example of the appearance of an image measuring apparatus 1.

FIG. 2 is a schematic diagram showing the internal structure of the image measuring apparatus 1.

FIG. 3 shows a functional block diagram of the image measuring apparatus 1 according to the first embodiment.

FIG. 4 shows an example of an image of the measurement object W.

FIG. 5 shows an example of the appearance of a caliper C.

FIG. 6 illustrates an example of a screen display where the caliper C is superimposed on the image of the measurement object W.

FIGS. 7A and 7B are schematic diagrams illustrating the movement of caliper C through a dragging operation.

FIGS. 8A, 8B, and 8C are schematic diagrams illustrating a plurality of calipers C being collectively moved.

FIG. 9 is a schematic diagram showing the adsorption process in which the caliper C is adsorbed onto the element E.

FIG. 10 is a schematic diagram showing an animation with acceleration and deceleration based on the easing curve during the adsorption process.

FIGS. 11A, 11B, and 11C are schematic diagrams illustrating the automatic movement of caliper C through a swipe operation.

FIGS. 12A, 12B, and 12C are schematic diagrams showing the automatic movement being resumed when the adsorption process is stopped.

FIGS. 13A, 13B, and 13C are schematic diagrams showing the process of adjusting the angle of the two calipers C in accordance with the combination of elements E adsorbed by the calipers C.

FIG. 14 is a flowchart showing the procedure for image measurement using the caliper C performed by the image measuring apparatus 1.

FIG. 15 shows a functional block diagram of the image measuring apparatus 1 according to the second embodiment.

FIGS. 16A, 16B, 16C, and 16D are diagrams showing specific examples of template T.

FIG. 17 is a schematic diagram showing the adsorption process in which the template T1 is adsorbed onto the elements E1 and E2.

FIG. 18 is a schematic diagram showing the adsorption process in which the template T3 is adsorbed onto the elements E1 and E2.

FIG. 19 shows an exemplary display of measurement values in the second embodiment.

### DETAILED DESCRIPTION OF THE EMBODIMENTS

Hereinafter, embodiments of the present invention will be described with reference to the drawings. In the following description and drawings, the same reference numeral is attached to the same functional parts, and the functional parts once explained are either omitted or explained to the extent necessary.

### First Embodiment

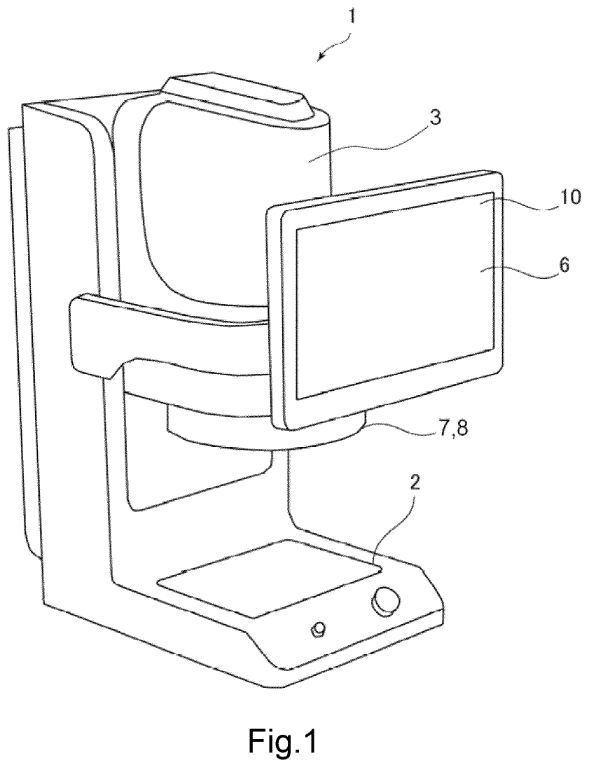

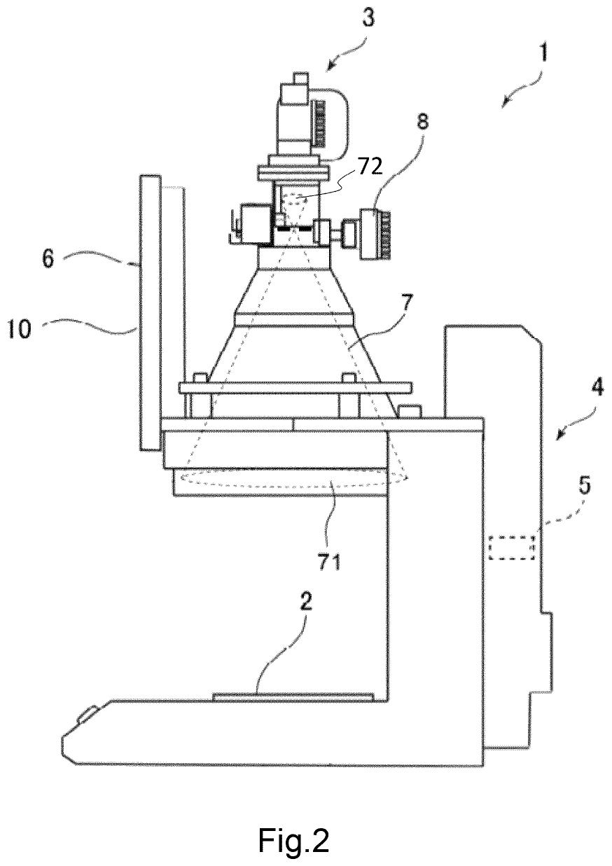

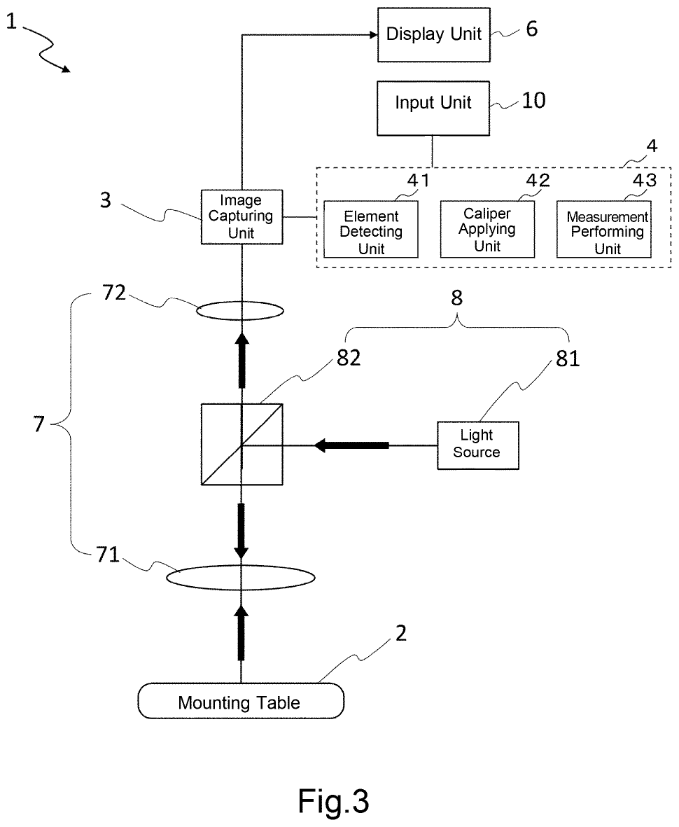

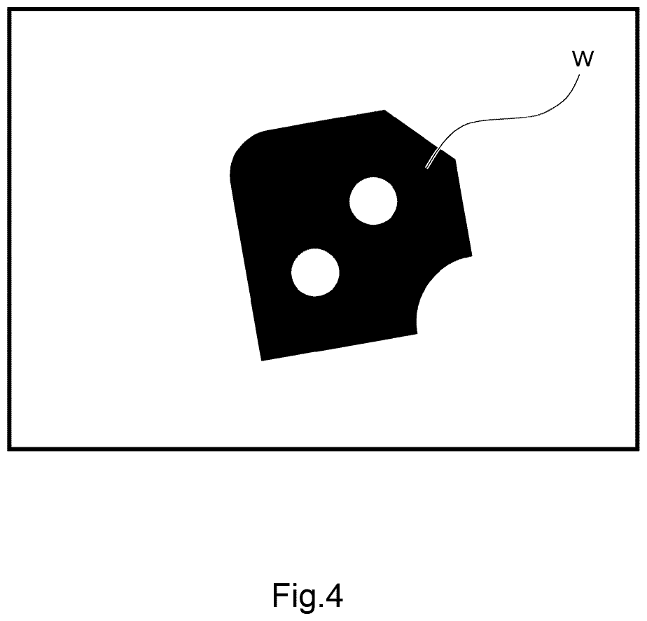

FIG. 1 is a schematic view illustrating the appearance of an image measuring apparatus 1 according to the first embodiment of the present invention. FIG. 2 is a schematic diagram showing the internal structure of the image measuring apparatus 1 according to the first embodiment. FIG. 3 shows a functional block diagram of the image measuring apparatus 1 according to the first embodiment. In the present embodiment, the case in which the coaxial episcopic illumination is adopted as the illumination method will be explained as an example. Still, any illumination method is acceptable as long as an image of a measurement object can be captured.

The image measuring apparatus 1 includes a mounting table 2, an image capturing unit 3, a control processing unit 4, a storage unit 5, a display unit 6, a telecentric optical system 7, an illumination unit 8, and an input unit 10.

The mounting table 2 is a platform on which the measurement object W is placed.

The image capturing unit 3 is disposed opposite the mounting table 2 and captures images of the measurement object W mounted on the mounting table 2 by receiving light from the direction of the mounting table 2. The image capturing unit 3 includes an image sensor, which converts the brightness or darkness of an image formed on its light-receiving surface into an electrical signal, thereby generating image data. For the image sensor, a semiconductor solid-state imaging device such as CCD (Charge-Coupled Device) or CMOS (Complementary Metal Oxide Semiconductor) is used.

The storage unit 5 is a generic storage medium capable of storing digital data.

The display unit 6 is a generic display means that displays the image of the measurement object W captured by the image capturing unit 3, etc. Additionally, the caliper is displayed semi-transparently as an overlay on the image of the measurement object W.

The telecentric optical system 7 comprises an objective lens 71 that collects light from the direction of the mounting table 2 and an imaging lens 72 that forms an image of the light passing through the objective lens 71 on the light-receiving surface of the image capturing unit 3. The objective lens 71 and the imaging lens 72 may each have a plurality of lens surfaces.

The illumination unit 8 is a coaxial episcopic illumination means provided with a light source 81 that emits illumination light and a beam splitter 82 that interrupts the illumination light from the light source 81 into the telecentric optical system 7 and directs the light toward the mounting table 2 as coaxial episcopic illumination light whose optical axis coincides with that of the image capturing unit 3. The illumination unit 8 may be equipped with transillumination or side illumination in addition to the coaxial episcopic illumination for image clarity and other purposes.

The input unit 10 accepts input operations by the user. The input unit 10 may be configured as a touch panel display integrated with the display unit 6, for example. In addition, the input unit 10 may be provided with a mouse in addition to or in place of the touch panel display.

The control processing unit 4 controls each part in the image measuring apparatus 1 and performs necessary arithmetic processing to realize image capture and image measurement by the image measuring apparatus 1.

In the image measuring apparatus according to the first embodiment, the control processing unit 4 includes an element detection unit 41, a caliper applying unit 42, and a measurement performing unit 43. The control processing unit 4 may be constituted by a CPU, and each function may be realized by executing a program that describes the functions of the element detection unit 41, the caliper applying unit 42, and the measurement performing unit 43, as well as the functions to control the image capturing unit 3, the illumination unit 8, etc., by the CPU. The program may be read from the storage unit 5 or from another storage medium. The control processing unit 4 and the storage unit 5 may be provided in the main body of the image measuring apparatus 1, or in a personal computer or other device that is communicatively connected to the main body of the image measuring apparatus 1.

The element detection unit 41 analyzes the image of the measurement object W captured by the image capturing unit 3 to detect the element E with the geometric shape in the image. For example, the element detection unit 41 detects elements E such as straight lines, intersection points, circle centers, circle diameters, arc centers, and arc diameters. With regard to the arc diameter, the element detection unit 41 may detect not only the diameter of the arc portion but also the diameter of the portion without an arc. The element detection unit 41 may cause the display unit 6 to display geometric shapes (line segments, arcs, etc.) representing the detected element E superimposed on the image of the measurement object W.

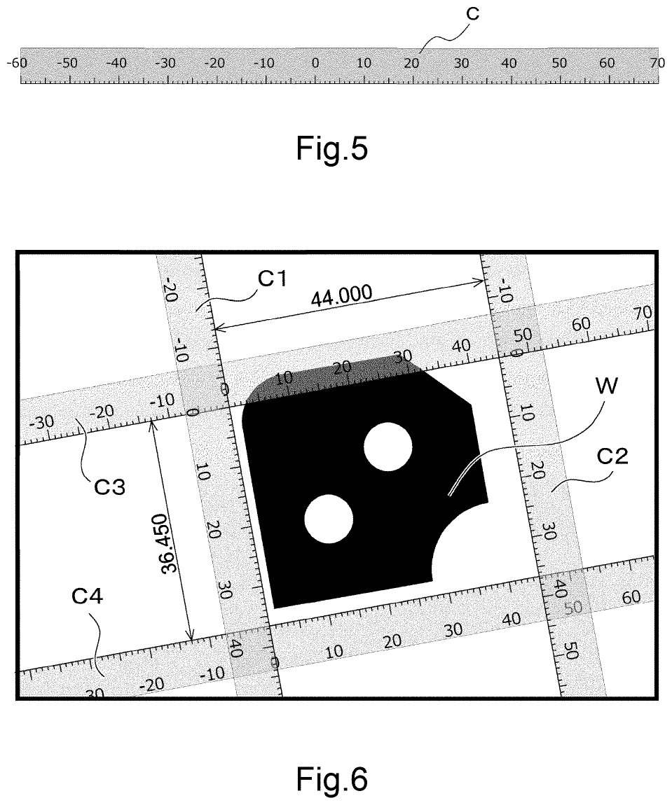

The caliper applying unit 42 causes display unit 6 to display the caliper C semi-transmissively at a predetermined transmittance superimposed on the image of the measurement object W. The caliper applying unit 42 corresponds to the measurement support item applying unit in the present invention, and the caliper C is a specific example of a measurement support item that the measurement support item applying unit causes the display unit to display. As shown in FIG. 5, the caliper C is a rectangular graphic that is positioned in accordance with the measurement point in the image of the measurement object W. One of the long sides of caliper C is a measurement edge that serves as the reference for measurement. As shown in FIG. 5, a scale is provided on the measurement edge. In the present embodiment, as shown in FIG. 6, four calipers C (C1 to C4) are displayed on the display unit 6. The four calipers C are paired in twos (i.e., the first pair consists of caliper C1 and caliper C2, and the second pair consists of caliper C3 and caliper C4). The paired calipers C are displayed so that the measurement edges are facing each other and in parallel. In the image measuring apparatus 1, the distance between the facing measurement edges of the paired calipers C is measured. The first paired calipers C (C1 and C2) and the second paired calipers C (C3 and C4) are displayed so that the measurement edges are perpendicular to each other (i.e., always maintaining a relative angle of 90 degrees).

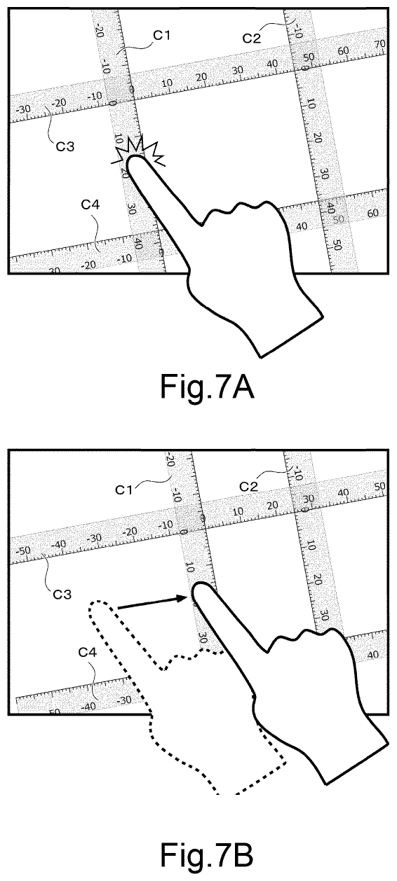

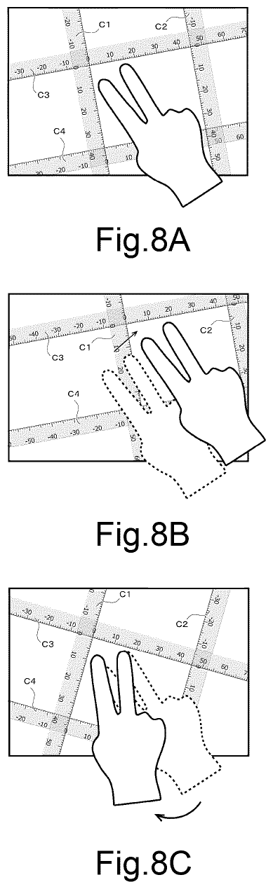

The position and orientation of the caliper C (C1 to C4) can be changed according to input to the input unit 10 by the user. When the input section 10 is a touch panel, as shown in FIGS. 7A and 7B, for each caliper C (any one of C1 to C4), the configuration may be provided such that the caliper C touched and slid by a single finger in the so-called drag operation is moved in accordance with the direction and amount of sliding. Furthermore, as in FIG. 8A changing to FIG. 8B, configuration may be provided such that the four calipers C are moved in parallel while maintaining their relative positions by performing a double-touch drag operation, which involves touching with two fingers and sliding. Furthermore, as in FIG. 8A changing to FIG. 8C, the configuration may be provided such that the four calipers C rotate while maintaining their relative positions by performing a so-called rotate operation, which involves rotating the contact position while touching two points.

Even when the input unit 10 is a mouse, operations for moving individual calipers C, parallel movement of the four calipers C, and rotation of the four calipers C may also be supported. The implementation method thereof is arbitrary, but for example, the movement of each caliper C can be achieved by a so-called drag-and-drop operation on each caliper C.

Furthermore, parallel movement and rotation of the four calipers C can be achieved by displaying control handles near the calipers C and performing drag-and-drop operations on the handles.

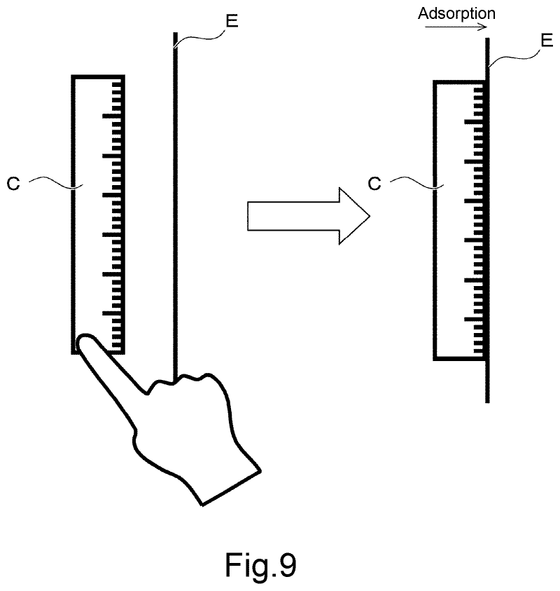

The caliper applying unit 42, as shown in FIG. 9, performs an adsorption process, which moves the caliper C in accordance with the element E when the caliper C is moved by a drag operation as described above, if the element E detected by the element detection unit 41 is present in the vicinity of the moved caliper C and the caliper C and the element E satisfy predetermined conditions (hereinafter called the adsorption criteria) depending on the type of the element E. For example, when the element E is a point (such as an intersection point or a center of a circle), the adsorption criteria is that the distance between the measurement edge of the caliper C after movement and element E is less than a predetermined value. When this criterion is satisfied, the caliper C is moved in parallel so that the measurement edge extends through the element E. When the element E is a straight line (such as a straight line or a diameter of a circle), the adsorption criteria is that the angle between the measurement edge of the caliper C after movement and element E is less than a predetermined value. When this criterion is satisfied, the caliper C is moved so that the measurement edge of the caliper C overlaps the element E.

By performing the adsorption process in this manner, it is possible to position the caliper C in accordance with element E without requiring precise alignment. The adsorption process enables the caliper C to be positioned in accordance with the element E through simple and intuitive rough operations, making it particularly useful when using the input unit 10 that is difficult to operate with fine movements, such as a touch panel.

In the image measuring apparatus 1, image measurement is performed according to the position of caliper C. Therefore, it is important for accurate measurement that the position of the element E to be measured and the position of caliper C are aligned. Typically, when the adsorption process is performed, the position of caliper C moves instantaneously. For this reason, it is easy for the user to confirm that the adsorption process has been performed (i.e., that caliper C has been accurately aligned with element E). However, in cases where the position of caliper C before the adsorption process is very close to element E (for example, when caliper C is positioned extremely close to element E by a drag operation), it may be difficult to determine whether the position of the element E to be measured and the position of caliper C are aligned. Additionally, in such cases, even if the adsorption process is performed, it may be difficult to visually confirm that caliper C has moved as a result of the adsorption process.

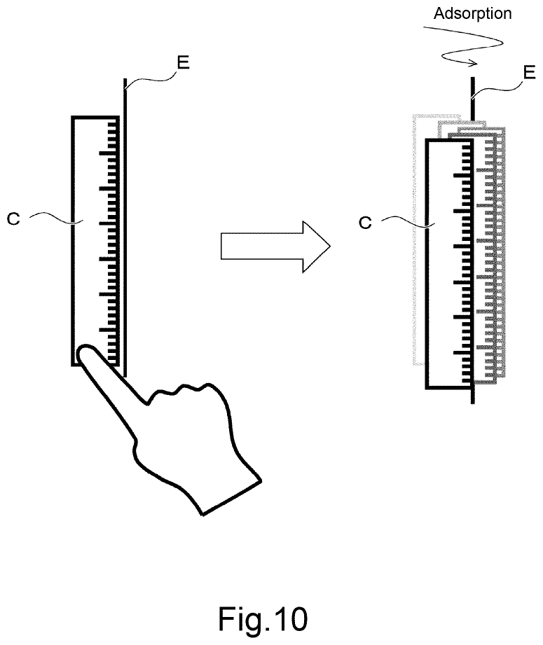

To address this issue, the caliper applying unit 42 of the present embodiment provides a notifying effect to the user that the adsorption process has been performed, regardless of the positional relationship between the element E and the caliper C before processing, when performing the adsorption process. For example, the caliper applying unit 42 may cause the movement of the caliper C due to the adsorption process to be displayed as an animation with acceleration and deceleration based on a predetermined easing curve, so that the user can visually confirm whether or not the adsorption process is occurring. More specifically, as shown in FIG. 10, the animation may be performed with a trajectory that moves from the initial position to a position beyond the element E to be adsorbed, and then returns to the element E. In this way, even when the initial positions of element E and caliper C are extremely close to each other, the user can clearly recognize that adsorption has occurred. In addition to visual indications, auditory indications such as buzzer sounds and tactile indications such as vibrations may be used to notify the user that the adsorption process has been performed.

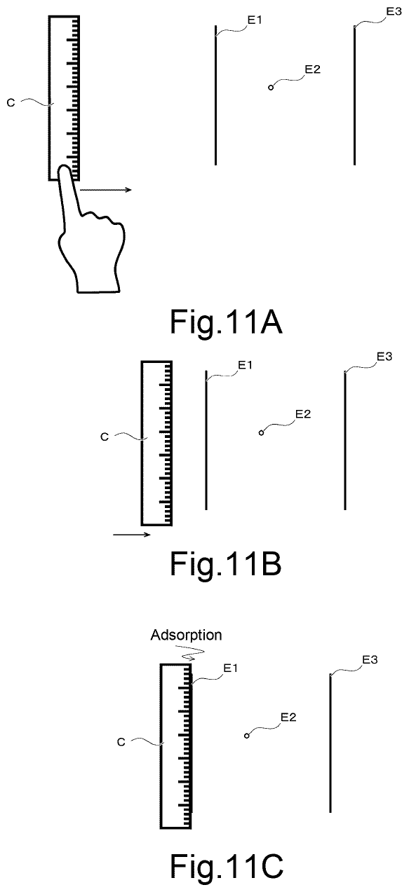

The caliper applying unit 42 moves the caliper C to the desired position and orientation by dragging it with a touch panel or mouse as described above. Although dragging is intuitive, easy to understand, and convenient, it requires the user to keep touching the touch panel while moving the caliper, which is physically burdensome. The caliper applying unit 42, in the configuration in which the touch panel is provided as the input unit 10, enables the caliper C to be positioned in accordance with the element E with easier operation. Specifically, in response to touch panel operations such as swiping or flicking, where a finger is placed on the touch panel and slid in any direction, the caliper C is automatically moved based on a movement speed determined by a vector defined by the direction and amount of finger movement (FIGS. 11A and 11B). The speed of this automatic movement is gradually decelerated using a constant friction coefficient (deceleration rate) until the speed reaches zero, at which point the caliper C is stopped. During this automatic movement, a search process is continuously performed to determine whether element E (E1 to E3) is present in the vicinity of the caliper C. Even during automatic movement, if any element E found in the vicinity of caliper C satisfies the adsorption criteria, the automatic movement is interrupted and the adsorption process is performed (FIG. 11C).

By such processing, the user can move caliper C easily by simply swiping or flicking, which is less burdensome than dragging. In addition, by searching for element E during automatic movement and performing the adsorption process, the caliper C can be positioned to be aligned with the element E to be measured by rough position designation.

Note that the method of stopping the automatically moving caliper C described above involves gradually decelerating the automatic movement speed at a constant deceleration rate until the speed reaches zero, at which point the caliper C is stopped. However, the method of stopping the automatically moving caliper C is not limited to this method. For example, the caliper C may be moved automatically without decelerating and stopped when it reaches a position where it cannot move further on the edge of the screen or stage. Alternatively, the caliper C may be moved automatically without deceleration and stopped when it has moved a certain distance, or when it has moved a distance determined based on a vector determined by the direction and amount of sliding of the finger.

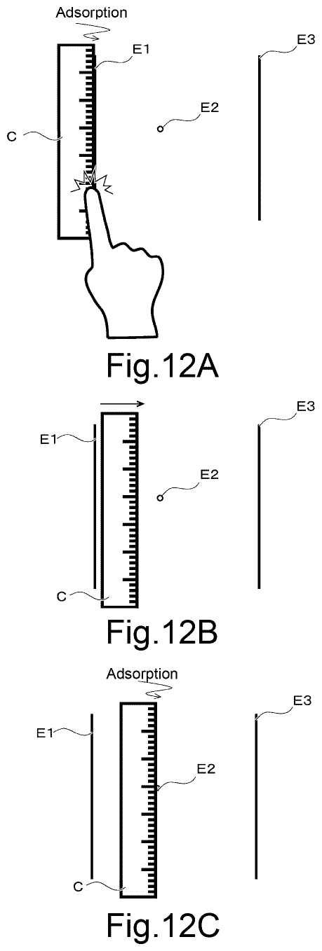

When the user performs a swipe or flick operation as described above, the caliper C is positioned in accordance with the first element E1. However, if the desired element E is the second or subsequent elements (E2 or E3), the swipe operation must be performed two or more times until the caliper C is adsorbed onto the desired element E. This operation is troublesome. Against this, when the caliper applying unit 42 detects that the user has touched the caliper C while the easing animation is being displayed during the adsorption process of the caliper C to the first element E1 (FIG. 12A), the caliper applying unit 42 cancels the adsorption process and resumes the movement of the caliper C (FIG. 12B). Then, if the next element E2 is detected in the vicinity of the caliper C during automatic movement and satisfies the adsorption criteria, the automatic movement is interrupted and the adsorption process for element E2 is performed (FIG. 12C).

With this feature, which interrupts the adsorption process and resumes automatic movement, users can select subsequent elements with a simple touching operation without having to perform significant hand movements such as swiping. Note that the operation to resume movement of the caliper C is not limited to touching the caliper C, but any operation may be assigned.

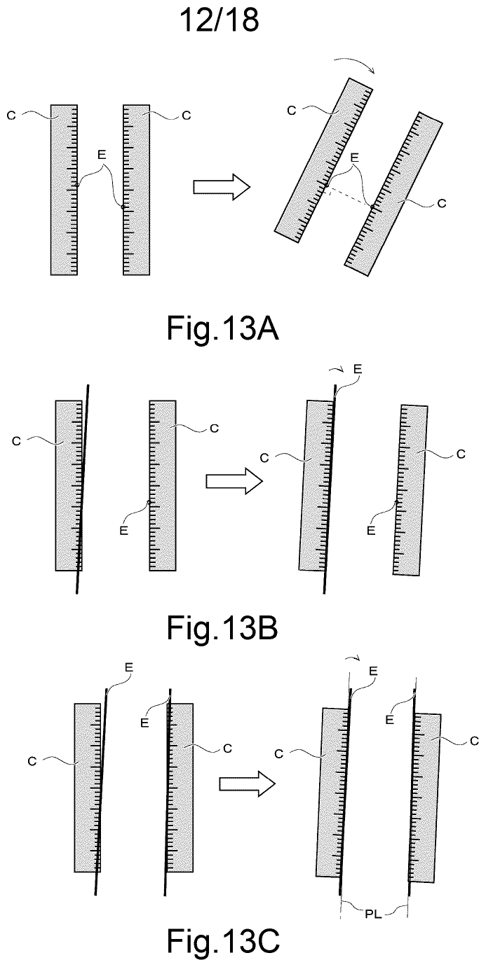

The caliper applying unit 42 corrects the angle of the caliper C in accordance with the combination of elements E to which the adsorption process of the two calipers has been applied, when the adsorption process has been performed on each element E with respect to the paired calipers C. For example, when the elements E adsorbed by the paired calipers C are both points (such as an intersection point or a center of a circle), the calipers C may be rotated so that the distance between the calipers C becomes the longest, as shown in FIG. 13A. This allows the distance between two points to be measured. When one of the elements E adsorbed by the paired caliper C is a point (intersection point, center of a circle, etc.) and the other is a line (straight line, diameter of a circle, etc.), the caliper C adsorbed onto the element E that is a line may be rotated so that the caliper C is aligned with the line, as shown in FIG. 13B. This allows the distance between the point and the line to be measured. When the elements E adsorbed by the paired calipers C are both lines, the two elements E are not necessarily parallel. For this reason, it is not possible to position the paired calipers C so that they completely align with both elements E. Therefore, as shown in FIG. 13C, parallel lines PL approximating the two elements E are calculated, and the calipers C are rotated so that they align with these lines. This allows the distance between the two lines to be measured. In addition, configuration may be provided to allow the user to select a mode in which the process of correcting the angle of the two calipers C in accordance with the combination of elements E adsorbed by the calipers C is not performed.

The measurement performing unit 43 causes the display unit 6 to display the measurement value based on the caliper C displayed on the display unit 6 by the caliper applying unit 42. That is, the measurement performing unit 43 constantly displays the distance between the first paired calipers C1 and C2, and the distance between the second paired calipers C3 and C4 on leader lines associated with the four calipers C. Thereby, the user can obtain the dimensions between the measurement edges of the paired calipers C. In addition, the measurement performing unit 43 saves the measurement values to a file upon request by the user. When the adsorption process is performed by the caliper applying unit 42, the angle of the calipers C is appropriately corrected according to the combination of elements E adsorbed by the calipers C, so that appropriate measurement values corresponding to the combination of elements E can be obtained.

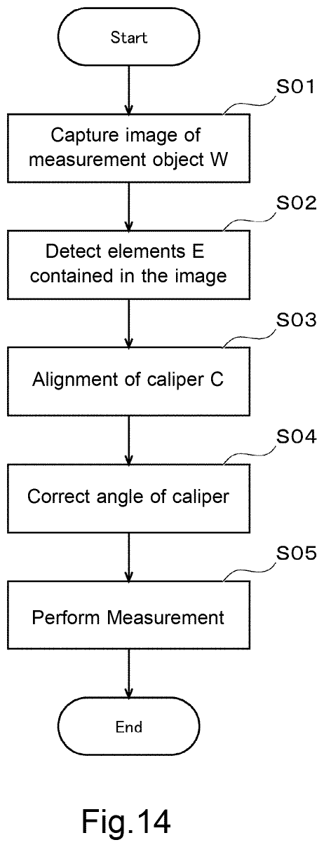

The following describes a typical procedure for performing image measurement using caliper C with the image measuring apparatus 1 configured as described above. FIG. 14 is a flowchart showing the procedure for image measurement using the caliper C performed by the image measuring apparatus 1.

First, the image capturing unit 3 captures an image of the measurement object W (step S01). The captured image of the measurement object W is displayed on display unit 6, and the caliper C is displayed superimposed on the image. In addition, the distance between the measurement edges of the paired calipers C is displayed. Then, the element detection unit 41 analyzes the image captured in step S01 and detects the elements E contained in the image (step S02). At this time, the detected elements E may be displayed as geometric shapes (line segments, arcs, etc.) superimposed on the image of the measurement object W. Next, based on the user's operation on the input unit 10 (e.g., drag or swipe operations on a touch panel), the caliper C is moved so that the measurement edge of the caliper C aligns with the element E corresponding to the measurement point (step S03). At this time, the caliper C is automatically and accurately aligned with element E by the adsorption process. Therefore, no fine adjustment operation is required to align the caliper C with the element E. In step S03, when the respective measurement edges of the paired calipers C are aligned with the two elements E corresponding to the measurement points, the caliper applying unit 42 corrects the angle of the calipers C according to the combination of elements E with which the calipers C are aligned (step S04). Then, for the calipers C with the angles corrected, the distance between the measurement edges of the paired calipers C is displayed as the final measurement value (step S05). The measurement values obtained in this manner may be recorded in the storage unit 5 as a measurement result file as needed, or the screen displayed on the display unit 6 may be recorded in the storage unit 5.

In this way, image measurement can be performed by aligning calipers C with the desired measurement points on the image of the measurement object W.

According to the image measuring apparatus and program of the first embodiment of the present invention described above, it is possible to overlay a caliper on the image of the measurement object and easily designate the measurement point by operating the caliper itself, thereby improving visual intuitiveness and ease of use. In addition, by simply bringing the caliper to the vicinity of the element, the user can designate the measurement point with rough operation by means of the adsorption process that aligns the position of the caliper with the element.

### Second Embodiment

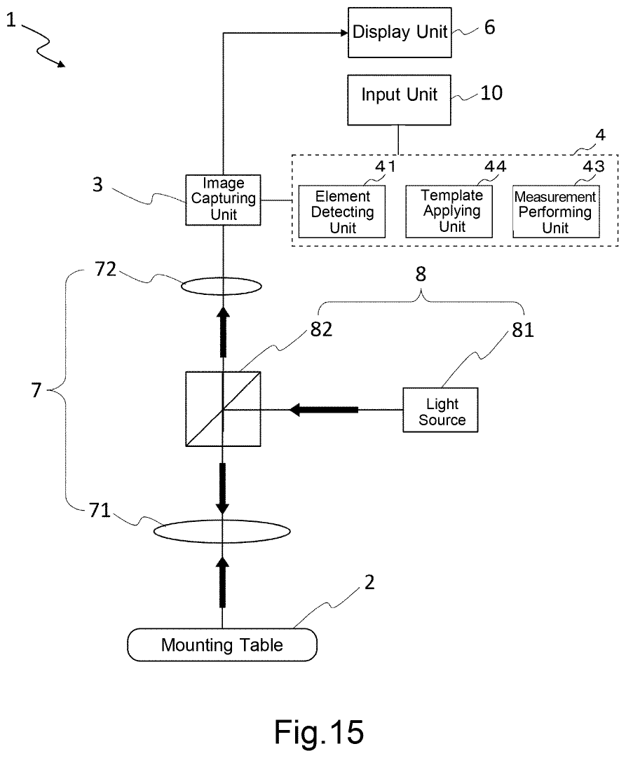

FIG. 15 shows a configuration of the image measuring apparatus 1 according to the second embodiment. The feature of the present embodiment lies in displaying a template T instead of the caliper C of the first embodiment. For other details, including the external appearance and internal structure, the same as described above in the first embodiment applies, so the explanation hereby is omitted.

The control processing unit 4 of the image measuring apparatus 1 according to the second embodiment includes a template applying unit 44 instead of the caliper applying unit 42 of the first embodiment. “The template applying unit 44 causes the display unit 6 to display the template T semi-transparently at a predetermined transmittance, superimposed on the image of the measurement object W. The template applying unit 44 corresponds to the measurement support item applying unit in the present invention, and the template T is a specific example of the measurement support item that the measurement support item applying unit causes the display unit to display.

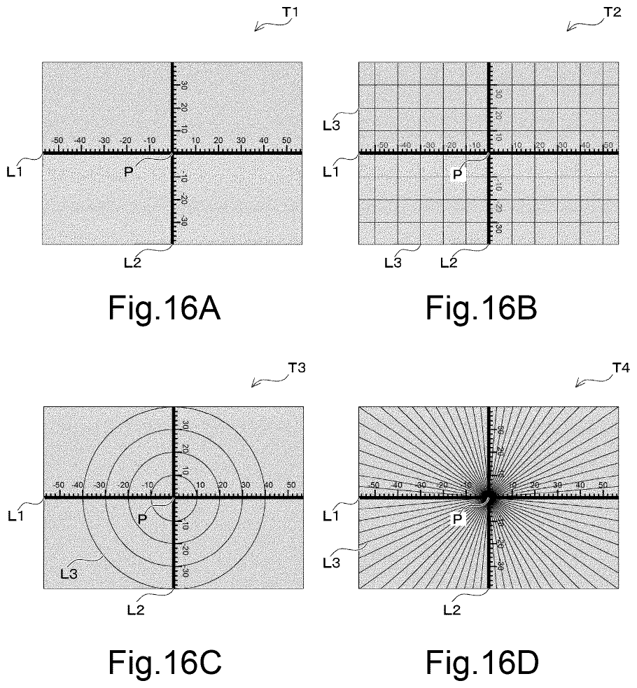

The template T is a graphic that is placed in accordance with the measurement points on the image of the measurement object W. There are various types of templates T, but the template T is configured to include at least a reference point and a reference line. The template T may further include information that supports in measurement (e.g., auxiliary lines, scale, characters indicating dimensions, or the like). FIG. 16 shows specific examples of the template T. Template T may be, for example: a cross-line template T1 (FIG. 16A) that has two reference lines L1 and L2 perpendicular to each other at a reference point P; a grid template T2 (FIG. 16B) that has two reference lines L1 and L2 perpendicular to each other at a reference point P and auxiliary lines L3 that are parallel to each reference line and arranged in a grid pattern; a concentric circle template T3 (FIG. 16C) that has two reference lines L1 and L2 perpendicular to each other at reference point P, and a plurality of auxiliary lines L3 that are concentric circles centered at the intersection of reference lines L1 and L2; A radial template T4 (FIG. 16D) that has two reference lines L1 and L2 perpendicular to each other at reference point P and a plurality of auxiliary lines L3 that are radial and pass through the intersection of reference lines L1 and L2; and the like. In any of the templates, scale, numbers representing dimensions, or the like may be provided along the reference lines (L1, L2) or auxiliary lines L3. The template applying unit 44 causes the display unit 6 to display one of the four types of templates T1 to T4 superimposed on the image of the measurement object W in accordance with the user's selection. Each template T may be configured so that the user can set the transparency when displaying semi-transparently, the coarseness of the scale, etc. Note that the template T may be a graphic that covers the entire screen of the display unit 6 even when its display position is changed, and that a portion of the template T is displayed within the display range of the display unit 6.

The initial indication of template T in display unit 6 may be at a predetermined position and orientation, but it is more desirable that template applying unit 44 estimates lines and a point that serve as references in the image of the measurement object W based on the elements detected by element detection unit 41, and that template T is displayed so that reference lines L1 and L2 and reference point P are aligned with those lines and point.

Similar to the first embodiment, in which the position and orientation of caliper C can be changed according to input to the input unit 10 by the user, the position and orientation of the template T can also be changed according to input to the input unit 10 (i.e., mouse operation or touch panel operation) by the user.

The template applying unit 44 performs the adsorption process, which moves the template T in accordance with the element E when the template T is moved by an input operation to the input unit 10, if the element E detected by the element detection unit 41 is present in the vicinity of the moved template T, and the template T and the element E satisfy predetermined conditions (hereinafter referred to as the adsorption criteria) depending on the type of the template T and the type of the element E.

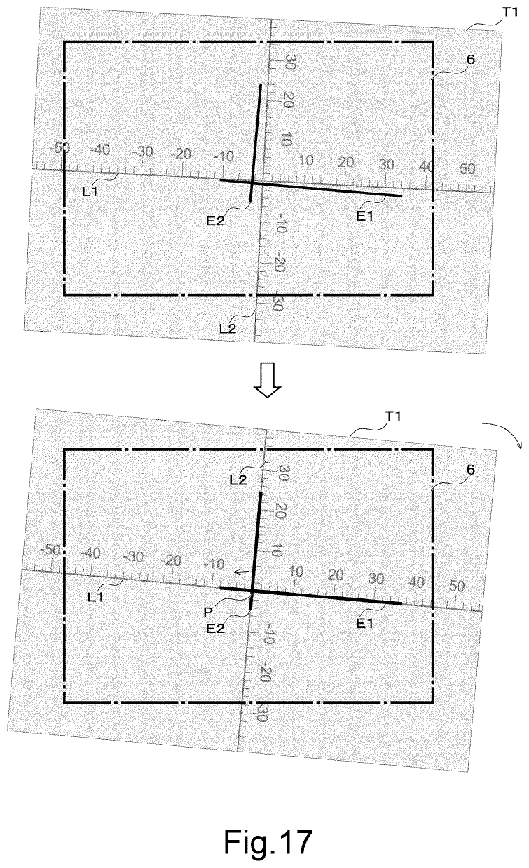

For example, as shown in FIG. 17, when the reference line L1 of the cross-line template T1 or the grid template T2 is positioned in accordance with a line-shaped element E1 (e.g., a straight line, diameter of a circle), the adsorption criteria may be set such that the angle formed between the reference line L1 and the element E1 in the moved template is less than or equal to a predetermined value. And, when this criterion is satisfied, the template T may be moved so that the reference line L1 overlaps with element E1. Furthermore, if there is another line-shaped element E2 that is generally orthogonal to element E1, and if the distance from reference point P to the intersection of elements E1 and E2 is less than a predetermined value (i.e., if template T is positioned such that two reference lines L1 and L2 generally overlap elements E1 and E2), the template T may be moved in parallel so that the reference point P is aligned with the intersection of elements E1 and E2. Note that in FIG. 17, the area outlined by a dashed rectangle represents the display area of the display unit 6.

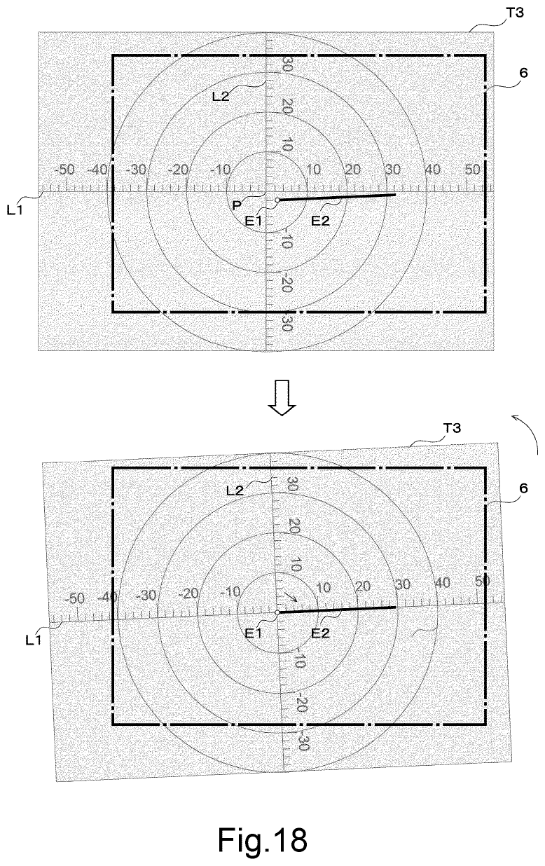

As shown in FIG. 18, when concentric circle template T3 or radial template T4 is positioned in accordance with a point element E1 (in the example of FIG. 18, the end point of a straight line), the adsorption criteria may be set such that the distance between the reference point P on the moved template and element E1 is less than or equal to a predetermined value. Then, when this condition is satisfied, the template T may be moved in parallel so that the reference point P overlaps with element E1. Furthermore, if there is an element E2 that passes through element E1 and the angle formed between one of the reference lines L1 or L2 and element E2 is less than a predetermined value, the template T may be rotationally moved around the reference point P so that the reference line (reference line L1 in the example of FIG. 18) overlaps with element E2. Note that in FIG. 18, the area outlined by a dashed rectangle represents the display area of the display unit 6.

By performing the adsorption process as exemplified above, it is possible to position the template T in accordance with the element E without requiring precise alignment. The adsorption process enables the template T to be positioned in accordance with the element E through simple and intuitive rough operations, making it particularly useful when using an input unit 10 that is difficult to operate with fine movements, such as a touch panel.

The template applying unit 44 provides a notifying effect to the user that the adsorption process has been performed so that the user can easily recognize that the adsorption process has been performed. This effect may be the same as the effect performed when the caliper applying unit 42 in the first embodiment performs the adsorption process on the caliper C.

In addition, the template applying unit 44 is configured to enable the template T to be positioned in accordance with the element E by simple operations suitable for a configuration in which the input unit 10 includes a touch panel, such as automatic movement in response to a swipe operation or a flick operation, deceleration of the automatic movement speed, adsorption process during automatic movement, and cancellation of the adsorption process and resumption of automatic movement, in the same manner as the caliper applying unit 42 in the first embodiment applied to the caliper C.

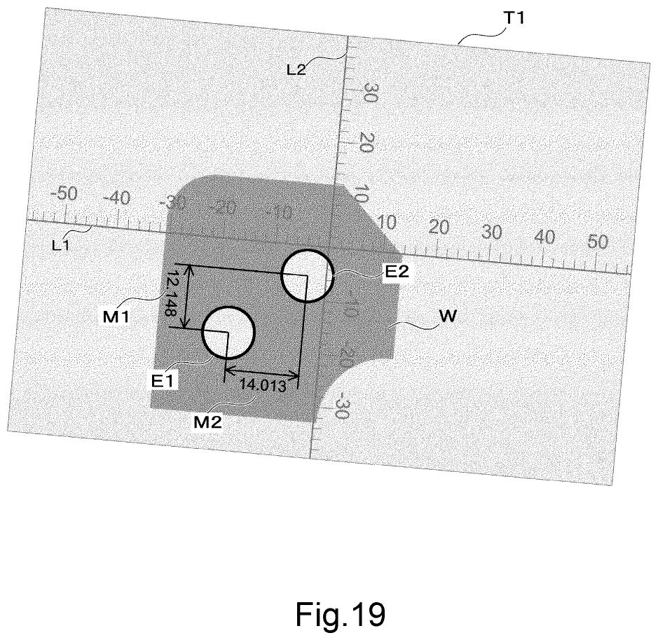

In the present embodiment, when an element detected by the element detection unit 41 is selected by an input operation (touching a touch panel, clicking with a mouse, etc.) to the input unit 10 while the template T is displayed superimposed on the image of the measurement object W, the measurement performing unit 43 displays the measurement values of the dimensions along the reference lines L1 and L2 of the shown template T for the selected element. For example, as shown in FIG. 19, when two circular elements (E1 and E2) are selected while the cross-line template T1 is displayed, the measurement performing unit 43 measures and displays the center-to-center distance of the circles in the directions along the two reference lines L1 and L2, as shown as M1 and M2 in the drawing.

According to the image measuring apparatus and program of the second embodiment of the present invention described above, it is possible to easily set the measurement reference axis by overlaying template T on the image of the measurement object W. In addition, it is possible to perform visual measurement by reading the scale on template T. In addition, by performing the adsorption process, which aligns the element and the template simply by bringing template T close to the element neighborhood, the user can position template T in accordance with the reference axis or point of the measurement object W with rough operations.

The present invention is not limited to the above embodiments and variations. The above-mentioned embodiments and variations are examples only, and anything having a configuration substantially the same as the technical idea described in the claims of the present invention and producing similar effects is included in the technical scope of the present invention. In other words, changes can be made as appropriate within the scope of the technical ideas expressed in the present invention, and forms with such changes and improvements are also included in the technical scope of the present invention.

With respect to the embodiments and modifications thereof, the following appendixes are further disclosed.

### APPENDIX 1

An image measuring apparatus that captures an image of a measurement object and measures the dimensions of the measurement point of the measurement object by analyzing the image, comprising:
a display unit that displays the image of the measurement object;
a measurement support item applying unit that causes the display unit to display a measurement support item superimposed on the image of the measurement object displayed on the display unit; and
an input unit that accepts input operations by a user for moving the measurement support item.

### APPENDIX 2

The image measuring apparatus according to appendix 1, further comprising an element detection unit that detects an element with the geometric shape appearing in the image, wherein the measurement support item applying unit performs an adsorption process, which moves the measurement support item in accordance with the element when the element detected by the element detection unit is present in the vicinity of the measurement support item and the measurement support item and the element satisfy a predetermined condition.

### APPENDIX 3

The image measuring apparatus according to appendix 2, wherein the measurement support item applying unit, when performing the adsorption process, provides a notifying effect to the user that the adsorption process has been performed.

### APPENDIX 4

The image measuring apparatus according to appendix 3, wherein the measurement support item applying unit performs, as the notifying effect, an animation displaying the movement of the measurement support item due to the adsorption process with acceleration and deceleration based on a predetermined easing curve.

### APPENDIX 5

The image measuring apparatus according to appendix 1, wherein a touch panel as the input unit is integrated with a display as the display unit to form a touch panel display, and when an operation of placing a finger on the touch panel and sliding the finger in any direction is performed, the measurement support item applying unit automatically moves the measurement support item by adding a movement speed determined based on a vector determined by the direction and amount of sliding of the finger to the measurement support item.

### APPENDIX 6

The image measuring apparatus according to appendix 5, further comprising an element detection unit that detects an element with the geometric shape appearing in the image, wherein the measurement support item applying unit, while automatically moving the measurement support item, stops the movement of the measurement support item and performs an adsorption process to move the measurement support item in accordance with the element when the element detected by the element detection unit is present in the vicinity of the measurement support item and the measurement support item and the element satisfy predetermined condition.

### APPENDIX 7

The image measuring apparatus according to appendix 6, wherein the measurement support item applying unit provides a notifying effect to the user that the adsorption process has been performed during the adsorption process, and when a predetermined operation is performed on the input unit while the notifying effect is being provided, the adsorption process is canceled and the movement of the measurement support item is resumed.

### APPENDIX 8

The image measuring apparatus according to appendix 6, wherein the measurement support item applying unit gradually decelerates the movement speed of the measurement support item at a constant deceleration rate while automatically moving the measurement support item, and stops the measurement support item at a position where the speed reaches zero.

### APPENDIX 9

The image measuring apparatus according to appendix 1, wherein the measurement support item applying unit causes paired calipers, which indicate the measuring points by measurement edges, to be displayed as the measurement support item such that the measurement edges of the paired calipers are in parallel and face each other, and the image measuring apparatus further comprises a measurement performing unit that performs measurement based on the distance between the measurement edges of the paired calipers.

### APPENDIX 10

The image measuring apparatus according to appendix 5, wherein the measurement support item applying unit causes the display unit to display two pairs of the paired calipers, and edge of the caliper the measurement constituting the first pair is perpendicular to the measurement edge of the caliper constituting the second pair.

### APPENDIX 11

The image measuring apparatus according to appendix 8, wherein the measurement support item applying unit corrects the angle of the caliper in accordance with the combination of elements to which the adsorption process of the each caliper has been applied, when the adsorption process has been performed on the element with respect to each of the paired calipers.

### APPENDIX 12

The image measuring apparatus according to appendix 1, wherein the measurement support item applying unit causes a template comprising at least a reference point and a reference line to be displayed as the measurement support item.

### APPENDIX 13

The image measuring apparatus according to appendix 12, wherein the measurement support item applying unit causes the display unit to display any one of:
a cross-line template that has two reference lines perpendicular to each other at a reference point;
a grid template that has two reference lines perpendicular to each other at a reference point and auxiliary lines that are parallel to each reference line and arranged in a grid pattern;
a concentric circle template that has two reference lines perpendicular to each other at reference point, and a plurality of auxiliary lines that are concentric circles centered at the intersection of reference lines; and
a radial template that has two reference lines perpendicular to each other at reference point and auxiliary lines that are radial and pass through the intersection point of reference lines,
as the template superimposed on the image of the measurement object.

### APPENDIX 14

The image measuring apparatus according to appendix 12, further comprising:
an element detection unit that detects an element with the geometric shape appearing in the image; and
a measurement performing unit that displays the measurement values of the dimensions along the reference lines of the shown template for the selected element, when an element detected by the element detection unit is selected by an input operation to the input unit while the template is displayed superimposed on the image of the measurement object.

### APPENDIX 15

The program that causes a computer to function as the image measuring apparatus according to in any one of appendixes 1 to 14.

1. An image measuring apparatus that captures an image of a measurement object and measures the dimensions of the measurement point of the measurement object by analyzing the image, comprising:
a display unit that displays the image of the measurement object;
a measurement support item applying unit that causes the display unit to display a measurement support item superimposed on the image of the measurement object displayed on the display unit; and
an input unit that accepts input operations by a user for moving the measurement support item.

2. The image measuring apparatus according to claim 1, further comprises an element detection unit that detects an element with the geometric shape appearing in the image,
wherein the measurement support item applying unit performs an adsorption process, which moves the measurement support item in accordance with the element when the element detected by the element detection unit is present in the vicinity of the measurement support item and the measurement support item and the element satisfy a predetermined condition.

3. The image measuring apparatus according to claim 2, wherein the measurement support item applying unit, when performing the adsorption process, provides a notifying effect to the user that the adsorption process has been performed.

4. The image measuring apparatus according to claim 3, wherein the measurement support item applying unit performs, as the notifying effect, an animation displaying the movement of the measurement support item due to the adsorption process with acceleration and deceleration based on a predetermined easing curve.

5. The image measuring apparatus according to claim 1, wherein a touch panel as the input unit is integrated with a display as the display unit to form a touch panel display, and
when an operation of placing a finger on the touch panel and sliding the finger in any direction is performed, the measurement support item applying unit automatically moves the measurement support item by adding a movement speed determined based on a vector determined by the direction and amount of sliding of the finger to the measurement support item.

6. The image measuring apparatus according to claim 5, further comprising an element detection unit that detects an element with the geometric shape appearing in the image,
wherein the measurement support item applying unit, while automatically moving the measurement support item, stops the movement of the measurement support item and performs an adsorption process to move the measurement support item in accordance with the element when the element detected by the element detection unit is present in the vicinity of the measurement support item and the measurement support item and the element satisfy predetermined condition.

7. The image measuring apparatus according to claim 6, wherein the measurement support item applying unit provides a notifying effect to the user that the adsorption process has been performed during the adsorption process, and
when a predetermined operation is performed on the input unit while the notifying effect is being provided, the adsorption process is canceled and the movement of the measurement support item is resumed.

8. The image measuring apparatus according to claim 6, wherein the measurement support item applying unit gradually decelerates the movement speed of the measurement support item at a constant deceleration rate while automatically moving the measurement support item, and stops the measurement support item at a position where the speed reaches zero.

9. The image measuring apparatus according to claim 1, wherein the measurement support item applying unit causes paired calipers, which indicate the measuring points by measurement edges, to be displayed as the measurement support item such that the measurement edges of the paired calipers are in parallel and face each other, and
the image measuring apparatus further comprises a measurement performing unit that performs measurement based on the distance between the measurement edges of the paired calipers.

10. The image measuring apparatus according to claim 5, wherein the measurement support item applying unit causes the display unit to display two pairs of the paired calipers, and
the measurement edge of the caliper constituting the first pair is perpendicular to the measurement edge of the caliper constituting the second pair.

11. The image measuring apparatus according to claim 8, wherein the measurement support item applying unit corrects the angle of the caliper in accordance with the combination of elements to which the adsorption process of the each caliper has been applied, when the adsorption process has been performed on the element with respect to each of the paired calipers.

12. The image measuring apparatus according to claim 1, wherein the measurement support item applying unit causes a template comprising at least a reference point and a reference line to be displayed as the measurement support item.

13. The image measuring apparatus according to claim 12, wherein the measurement support item applying unit causes the display unit to display any one of:
a cross-line template that has two reference lines perpendicular to each other at a reference point;
a grid template that has two reference lines perpendicular to each other at a reference point and auxiliary lines that are parallel to each reference line and arranged in a grid pattern;
a concentric circle template that has two reference lines perpendicular to each other at reference point, and a plurality of auxiliary lines that are concentric circles centered at the intersection of reference lines; and
a radial template that has two reference lines perpendicular to each other at reference point and auxiliary lines that are radial and pass through the intersection point of reference lines,
as the template superimposed on the image of the measurement object.

14. The image measuring apparatus according to claim 12, further comprises:
an element detection unit that detects an element with the geometric shape appearing in the image; and
a measurement performing unit that displays the measurement values of the dimensions along the reference lines of the shown template for the selected element, when an element detected by the element detection unit is selected by an input operation to the input unit while the template is displayed superimposed on the image the of measurement object.

15. The program that causes a computer to function as the image measuring apparatus as claimed in claim 1.
